(19) United States
(12) Patent Application Publication
(10) Pub. No.: US 2007/0224981 A1
(43) Pub. Date: Sep. 27, 2007

(54) SYSTEM FOR CONTROLLING MOBILE INTERNET INTERFACE

(75) Inventor: Jin Soo YOUN, Ansan-shi (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/564,411

(22) Filed: Nov. 29, 2006

(30) Foreign Application Priority Data
Mar. 21, 2006 (KR) 10-2006-0025595

(51) Int. Cl. H04M 3/00

(52) U.S. Cl. 455/418

(57) ABSTRACT

A system and method for controlling a mobile Internet interface includes a mobile terminal having a mobile Internet module. The system includes a controller configured for activating the mobile terminal from a sleep mode based upon an occurrence of a wake-up event. The mobile terminal is activated from the sleep mode based upon the occurrence of a wake-up event, such as an Internet call received through the mobile Internet module or an input of a predetermined key or key combination by a user through the mobile terminal.

### BACKGROUND

This description relates to a system for controlling a mobile Internet interface.

A mobile Internet system allows a user to receive various information and content at high speed by accessing the Internet using a mobile terminal without time and spatial restrictions. The mobile Internet system allows a user to receive high speed Internet service whether the user is traveling or the user is at a predetermined, stationary location.

For example, a Wireless Broadband Internet (WiBro) system is one type of representative mobile Internet system used in Korea and compatible with (WiMax) Worldwide Interoperability for Microwave Access, a certification mark for products that pass conformity and interoperability tests for the IEEE 802.16 and ETSI HiperMAN standards. WiMAX is a standards-based wireless technology that provides high-throughput broadband connections over long distances.

The mobile Internet system provides a seamless wireless Internet service within a cell range using a predetermined frequency band while a user is traveling, and even when the user is traveling at a relatively high speed. The mobile Internet system service is received through a mobile Internet module mounted to a mobile device, such as a notebook computer. The module may include a wireless LAN card or a USB LAN card. After connecting through the mobile Internet system service, a user's mobile device is capable of displaying movies, playing on-line games, or browsing the Web in a manner similar to a more traditional wired Internet service, even though the user is operating through a wireless connection and while moving at high speeds, such as while traveling in a car.

For example, WiBro provides various content to users at a high transmission rate and low cost, while also providing mobility. WiBro is expected to provide fast Internet access and high speed data transmission in a manner faster than a conventional wired Internet system. In addition, systems such as WiBro are capable of providing a wider range of mobile Internet service compared to current wireless Internet service, such as through a wireless LAN or CDMA. In addition, a variety of content will be available for download through WiBro terminals by accessing the Internet through a wireless communication link.

Such a mobile Internet service allows a user to use the high-speed Internet through the wireless communication link while the user is traveling using a notebook computer, a personal data assistant (PDA), a portable terminal for vehicle, or a handheld terminal. Accordingly, a mobile computing terminal that includes a mobile Internet module, for example, a WiBro module, to receive the mobile Internet service, is desirable.

### SUMMARY

In one general aspect, an interface system is provided between a mobile Internet module mounted at a terminal and a chipset of the terminal in a mobile Internet system.

In another general aspect, a system for controlling a mobile Internet interface includes a mobile terminal including a mobile Internet module. The system includes a controller configured for activating the mobile terminal from a sleep mode based upon an occurrence of a wake-up event initiated with the mobile Internet module.

Implementations may include one or more of the following features. For example, the mobile Internet module may perform operations for accessing the Internet through a wireless communication link.

The mobile terminal may includes an antenna supporting wireless Internet access. The controller can activate the mobile terminal from the sleep mode in response to the occurrence of the wake-up event, such as a receipt of a signal through the antenna.

The mobile internet module may be embedded in the mobile terminal, or the mobile Internet module may be operatively and removably connected to the mobile terminal through a pinned connection.

The mobile terminal may include a notebook computer, a personal data assistant (PDA), and/or a mobile phone.

The controller may activate the mobile terminal from the sleep mode in response to the occurrence of the wake-up event. The wake-up event may include a user-initiated input to a controller operatively connected to the mobile terminal.

In another general aspect, a system for controlling a mobile Internet interface includes a mobile Internet module, an interface controller configured to detect the presence of the mobile Internet module and to control data input and output based upon the presence of the mobile Internet module, and a first controller configured to output a first control signal in response to a wake-up signal received by the mobile Internet module. The system includes a second controller configured for activating the mobile Internet module in response to the first control signal output from the first controller and for supplying a system power to the mobile Internet module and the interface controller. The system also includes a switching unit configured for selectively activating the mobile Internet module and the interface controller in response to the second controller.

Implementations may include one or more of the following features. For example, the mobile Internet module may perform operations for accessing the Internet through a wireless communication link.

The first controller may be a keyboard controller, and the second controller may be an ICH6-based power management controller. The interface controller may be a SDIO controller.

The first controller may enable and disable, or activate and deactivate, the mobile interface module. For example, the first controller may turn the mobile interface module on and off in response to an input of a predetermined key or a predetermined key combination to a mobile terminal operatively connected with the mobile interface module.

The first controller may activate the mobile terminal from a sleep mode in response to the occurrence of a wake-up event. The wake-up event may include receipt of a signal through the mobile Internet module, a user-initiated input to a controller operatively connected to the mobile terminal, and/or a call event from an Internet telephone transmitted to the mobile Internet module.

In another general aspect, activating a mobile terminal having a mobile Internet module from a sleep mode includes determining whether a wake-up event for the mobile Internet module has occurred. The mobile terminal is activated from the sleep mode based upon the occurrence of the wake-up event.

Implementations may include one or more of the following features. For example, the mobile terminal may be activated from the sleep mode in response to the occurrence of the wake-up event, which may include one or more of a user-initiated input to the mobile terminal, a call event of an Internet telephone, or an operative connection between the mobile Internet module and the mobile terminal.

In another general aspect, controlling a power supply to a mobile terminal having a mobile Internet module includes determining if a predetermined key is input to the mobile terminal. The mobile Internet module is selectively controlled if the predetermined key is input to the mobile terminal.

Implementations may include one or more of the following features. For example, the mobile Internet module may be selectively controlled by enabling or disabling the mobile Internet module, or by activating the mobile Internet module from a sleep mode.

Other features will be apparent from the following description, including the drawings, and the claims.

### BRIEF DESCRIPTION OF THE DRAWINGS

FIG. 1 is a block diagram of a mobile Internet interface system.

FIG. 2 shows a pin configuration for a mobile Internet module in a mobile Internet interface system.

FIGS. 3A and 3B are timing diagrams for a mobile Internet interface system.

FIG. 4 is a flowchart of a process for controlling a mobile Internet interface system.

FIG. 5 is a flowchart of a process for controlling a mobile Internet interface system.

### DETAILED DESCRIPTION

In general, the same reference numbers will be used throughout the drawings to refer to the same or like parts.

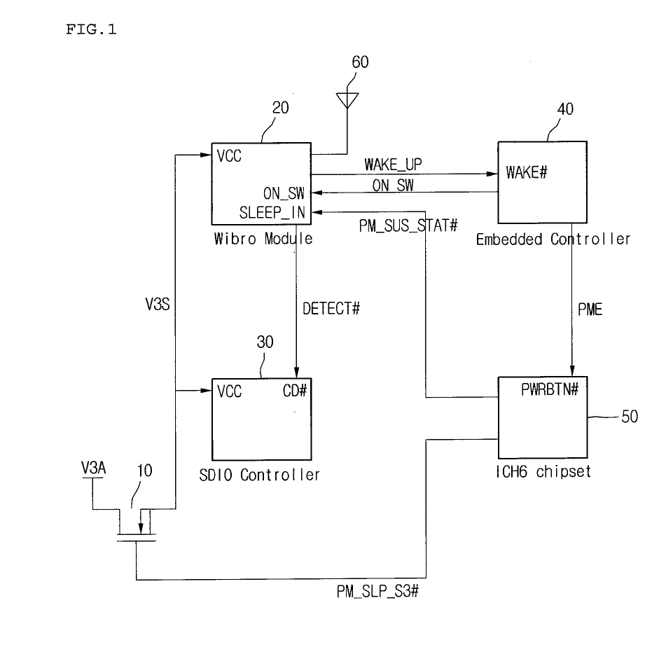

Referring to FIG. 1, a mobile Internet interface system includes a switching unit 10, a mobile Internet module 20, a (SDIO) Secure Digital IO controller 30, a first controller 40, and a second controller 50. The mobile Internet module 20 may be a variety of Internet modules, including a WiBro module mounted at a mobile terminal or connected to the mobile terminal through an interface if the module 20 is an external device. The first controller 40 may be an embedded controller, such as, for example, a keyboard controller. The second controller 50 may be an ICH6 chipset to manage power. As shown, the mobile Internet interface system may be applied to or integrated with a variety of mobile terminals, such as a notebook computer, a personal data assistant (PDA), and/or a mobile phone.

The switching unit 10 controls power (V3A=>V3S, VCC) supplied to the WiBro module 20 and the SDIO controller 30 in response to signals from the second controller 50 (e.g., the ICH6 chipset). The WiBro module 20 is connected to an antenna 60 to access the wireless Internet. The WiBro module 20 receives power in response to the switching unit 10 and outputs a wake-up signal (WAKE_UP) when the system state changes from a sleep mode to a wake-up mode. The WiBro module 20 also receives an on_switch signal (ON_SW) from the first controller 40 when the WiBro module is powered on. Furthermore, the WiBro module 20 receives a sleep_in signal (SLEEP_IN) when the system state changes to the sleep mode in response to a power control signal (PM_SUS_STAT#) from the second controller 50. When the WiBro module is integrated with a system, the WiBro module 20 outputs a signal (DETECT#) to inform the SDIO controller 30 of the connection with the WiBro module through an input end (CD#) of the SDIO controller 30.

The first controller 40 is an embedded controller which outputs a power_on signal (ON_SW) when the power is supplied to the WiBro module 20 and receives a wake-up signal (WAKE_UP) from the WiBro module 20. The first controller 40 outputs a power management event signal (PME) when it receives the wake-up signal (WAKE_UP) to inform the second controller 50 of the change in system state.

The second controller 50 outputs a power control signal (PM_SUS_STAT#) to the WiBro module 20 and outputs a control signal (PM_SLP_S3#) to control the switching unit 10. The second controller 50 also receives the PME signal from the first controller 40 at the input end (PWRBTN#) to change the system state from the sleep mode to the wake-up mode.

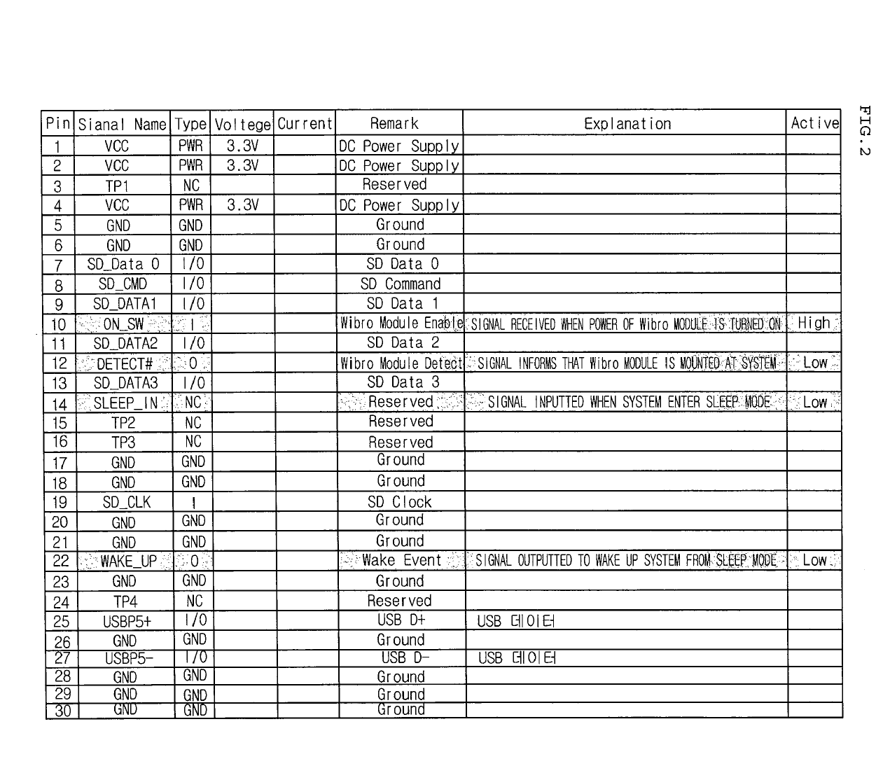

Referring to FIG. 2, the ON_SW signal is defined as an input signal to enable the WiBro module. The ON_SW signal is received when the WiBro module is powered on and operated at Active High. The DETECT# signal is defined as an output signal to detect the WiBro module. The DETECT# signal indicates when the WiBro module is mounted at the system and is operated at Active Low. The SLEEP_IN signal is defined as an input signal received when the system is transited to the sleep mode. The WAKE_UP signal is an output signal operated at Active Low and initiated by a Wake Event towake up the system from the sleep mode.

When a notebook computer having the WiBro module 20 enters into an S3 mode (sleep mode), the mobile Internet interface system sends a notification of the change in system state to the sleep mode to an input end (SLEEP_IN) of the WiBro module 20. The system enters into the suspend mode from the ICH6 50. If the notebook computer receives a predetermined event, such as a call event of an Internet telephone through a wireless network, the WiBro module 20 outputs the wake-up signal (WAKE_UP) to the system. The predetermined event can be a user entered input, such as inputting a predetermined key or keys, and/or an external call signal which is received through the antenna 60. A wake-up signal is output to the embedded controller 40 and the embedded controller 40 generates a power management event (PME) to supply power to the SDIO controller 30 and the WiBro module 20.

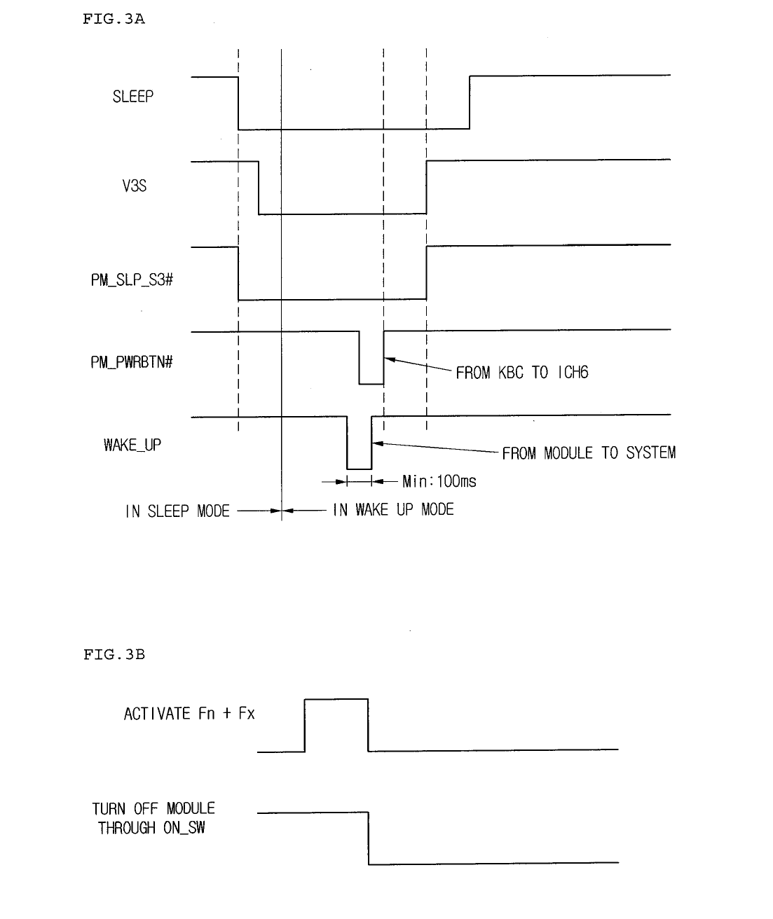

Referring to FIG. 3A, a system in the sleep mode is woken up in response to receipt of a predetermined event signal, e.g., such as an Internet call (VoIP telephone call). The relative timing of the various signals for waking up the system, i.e., Wake_UP, the SLEEP_IN signal, the power V3S signal, the PM_SLP_S3# signal, the PM_PWRBTN# signal and the WAKE_UP signal are shown in FIG. 3A. Referring to FIG. 3B, the relative signal timing during a system shutdown operation is shown. Such a shutdown may be initiated, for example, by user input of a predetermined key combination (e.g., Fn+Fx). When the WiBro module is turned on/off by a predetermined key combination (e.g., Fn+Fx) made by a user, the module is turned off through the interruption of the ON_SW signal to the WiBro module.

If a notebook computer system having the WiBro module 20 enters a sleep mode (S3 mode), the SLEEP_IN signal becomes the Active Low signal to indicate that the notebook computer is entering a sleep mode. The second controller 50 outputs the power control signal (PM_SUS_STAT#) to the WiBro module 20 to change the SLEEP_IN signal to an Active Low signal.

When the notebook computer transitions to the sleep mode, the PM_SLP_S3# signal becomes low. The second controller 50 outputs the control signal (PM_SLP_S3#) to the switching unit 10, and the switching unit 10 interrupts the power (V3A=>V3S, VCC) supplied to the WiBro module 20 and the SDIO controller 30 to deactivate the WiBro module (sleep mode).

As described above, the PM_PWPBTN# signal of the second controller 50 and the WAKE_UP signal of the WiBro module 20 are relatively high while the system is in the sleep mode. The notebook computer system in the sleep mode is woken, e.g., activated, in response to a predetermined event received by the system, e.g., an incoming call event from an Internet telephone via a wireless network connected through the antenna 60.

For example, if the WiBro module 20 receives a data packet through the antenna 60, a wake-up event is generated that will transition the system from the sleep mode to an active state. The wake-up event may be a call event of an Internet telephone, and/or a predetermined or user-defined input on a keyboard or controller. The WiBro module 20 outputs the WAKE_UP signal to the first controller 40, and the WAKE_UP signal is input to an input end (WAKE#) of the first controller 40. The WAKE_UP signal is recognized as a time-based signal. In addition, as shown in FIG. 3A, the WAKE_UP signal is maintained at a relatively low level for at least 100 msec.

The first controller 40 generates the power management event (PME) and the PWRBTN# signal is output to the second controller 50. The second controller 50 outputs the control signal (PM_SLP_S3#) to the switching unit 10. The switching unit 10 is next driven by the PM_SLP_S3# signal, and the power (V3A=>V3S, VCC) is supplied to the WiBro module 20 and the SDIO controller 30. The second controller 50 also outputs the PM_SUS_STAT# signal to make the SLEEP_IN signal of the WiBro module 20 transition to a relatively high signal. Accordingly, the notebook computer system can be woken up from a sleep mode when the predetermined event, such as a call event from an Internet phone, is received.

FIG. 3B shows signal timing for various signals within the system. The timing for turning on and off the WiBro module is made by a predetermined key combination (e.g., Fn+Fx) by a user. For example, if a predetermined key combination (e.g., Fn+Fx) is recognized by the second controller 40, e.g., a keyboard controller (KBC), the second controller 40 outputs the ON_SW signal to the WiBro module 20 to turn off the WiBro module 20. Since a user may not want to always use the WiBro module when using the notebook computer system, a function of turning on and/or off the WiBro module is provided for the user to have control over network connectivity.

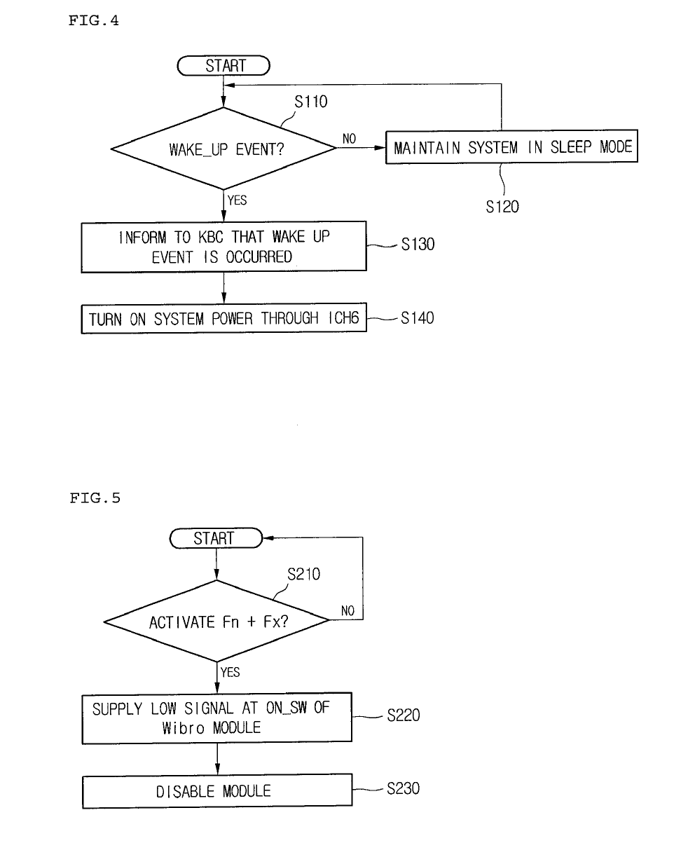

Referring to FIG. 4, the mobile Internet interface system is awoken from a sleep mode in response to or upon receipt of a call event from an Internet phone. In operation S110, the system determines if a wake-up event has occurred, such as a call event from an Internet telephone, while the notebook computer system is in the sleep mode. If the notebook computer system having the WiBro module 20 enters the sleep mode (S3 mode), the WiBro module 20 is notified of the transition to the sleep mode by by the SLEEP_IN signal, and the notebook computer system enters in the sleep mode from the ICH6. If the wake-up event has not occurred, the sleep mode of the system is maintained in operation S120 and the system continuously determines whether the wake-up event has occurred or not in operation S110.

In operation S110, if the wake-up event has occurred, e.g., a call event from the Internet telephone, the WiBro module 20 outputs the WAKE_UP signal to the first controller to notify the system of the occurrence of the wake-up event in operation S130.

In operation S140, the first controller 40 outputs the PWRBTN# signal to the second controller 50 and the second controller 50 turns the switching unit 10 on using the PM_SLP_S3# signal to supply the power to the WiBro module 20 and the SDIO controller 30. The second controller 50 outputs the PM_SUS_STAT# signal to the WiBro module 20 as the SLEEP_IN signal to supply power to the system for waking up the system. By supplying power to the system through the ICH6 in operation S140, the WiBro module 20 effectively responds to a wake-up event(s), such as the call event from the Internet telephone, even though the notebook system was in the sleep mode.

Referring to FIG. 5, the WiBro module 20 can be enabled and/or disabled with a predetermined key combination. The first controller 40, e.g., a keyboard controller, determines whether a predetermined key (e.g., Fn) or key combination (e.g., Fx+Fn) is input or not in operation S210. If the predetermined key or key combination is input in operation S210, the first controller 40 outputs a relatively low signal to the WiBro module 20 as the ON_SW signal in operation S220 so that the WiBro module 20 becomes disabled. In contrast, if another predetermined key or key combination is input in operation S210, the second controller 40 outputs a relatively high signal to the WiBro module 20 as the ON_SW signal. The WiBro module 20 then becomes enabled in order to establish a wireless Internet connection using the WiBro module 20. Accordingly, the WiBro module 20 may be enabled or disabled by inputting a predetermined key or key combination.

It will be apparent that various modifications and variations can be made. For example, the system can include a variety of wireless Internet modules, including a WiBro module, a WiMax module, and/or other modules supporting similar wireless Internet connections.

What is claimed is:

1. A system for controlling a mobile Internet interface comprising:
a mobile terminal including a mobile Internet module; and
a controller configured for activating the mobile terminal from a sleep mode based upon an occurrence of a wake-up event initiated with the mobile Internet module.

2. The system according to claim 1, wherein the mobile Internet module is configured for performing operations for accessing the Internet through a wireless communication link.

3. The system according to claim 1, wherein the mobile terminal comprises an antenna configured for supporting wireless Internet access.

4. The system according to claim 1, wherein the mobile internet module is embedded in the mobile terminal.

5. The system according to claim 1, wherein the mobile Internet module is operatively and removably connected to the mobile terminal through a pinned connection.

6. The system according to claim 1, wherein the mobile terminal comprises a notebook computer, a personal data assistant (PDA), or a mobile phone.

7. The system according to claim 3, wherein the controller is configured for activating the mobile terminal from the sleep mode in response to the occurrence of the wake-up event, the wake-up event comprising receipt of a signal through the antenna.

8. The system according to claim 3, wherein the controller is configured for activating the mobile terminal from the sleep mode in response to the occurrence of the wake-up event, the wake-up event comprising a user-initiated input to a controller operatively connected to the mobile terminal.

9. A system for controlling a mobile Internet interface comprising:
a mobile Internet module;
an interface controller configured for detecting the presence of the mobile Internet module and for controlling data input and output based upon the presence of the mobile Internet module;
a first controller configured for outputting a first control signal in response to a wake-up signal received by the mobile Internet module;
a second controller configured for activating the mobile Internet module in response to the first control signal output from the first controller and for supplying a system power to the mobile Internet module and the interface controller; and
a switching unit configured for selectively activating the mobile Internet module and the interface controller in response to the second controller.

10. The system according to claim 9, wherein the mobile Internet module is configured for performing operations for accessing the Internet through a wireless communication link.

11. The system according to claim 9, wherein the first controller is a keyboard controller.

12. The system according to claim 9, wherein the second controller is an ICH6 based power management controller.

13. The system according to claim 9, wherein the interface controller is a SDIO controller.

14. The system according to claim 9, wherein the first controller is configured for enabling and disabling the mobile interface module.

15. The system according to claim 9, wherein the first controller is configured for activating and deactivating the mobile interface module.

16. The system according to claim 9, wherein the first controller is configured for turning the mobile interface module on and off in response to an input of a predetermined key or a predetermined key combination to a mobile terminal operatively connected with the mobile interface module.

17. The system according to claim 9, wherein the first controller is configured for activating the mobile terminal from a sleep mode in response to the occurrence of a wake-up event.

18. The system according to claim 17, wherein the wake-up event comprises receipt of a signal through the mobile internet module.

19. The system according to claim 17, wherein the wake-up event comprises a user-initiated input to a controller operatively connected to the mobile terminal.

20. The system according to claim 17, wherein the wake-up event comprises a call event from an Internet telephone transmitted to the mobile Internet module.

21. A method for activating a mobile terminal having a mobile Internet module from a sleep mode, comprising:
determining if a wake-up event for the mobile Internet module has occurred; and
activating the mobile terminal from the sleep mode based upon the occurrence of the wake-up event.

22. The method according to claim 21, wherein activating the mobile terminal from the sleep mode occurs in response to the occurrence of the wake-up event.

23. The method according to claim 22, wherein the wake-up event comprises a user-initiated input to the mobile terminal, a call event of an Internet telephone, or an operative connection between the mobile Internet module and the mobile terminal.

24. A method for controlling a power supply to a mobile terminal having a mobile Internet module, comprising:
determining if a predetermined key is input to the mobile terminal; and
selectively controlling the mobile Internet module if the predetermined key is input to the mobile terminal.

25. The method according to claim 24, wherein selectively controlling the mobile Internet module comprises enabling or disabling the mobile Internet module.

26. The method according to claim 24, wherein selectively controlling the mobile Internet module comprises activating the mobile Internet module from a sleep mode.
